(19) United States
(12) Patent Application Publication
(10) Pub. No.: US 2016/0223475 A1
(43) Pub. Date: Aug. 4, 2016

(54) Method of exact image reconstruction for cone beam tomography with arbitrary source trajectory

(71) Applicant: Victor Palamodov, Karlsruhe (DE)

(72) Inventor: Victor Palamodov, Karlsruhe (DE)

(21) Appl. No.: 14/608,245

(22) Filed: Jan. 29, 2015

(51) Int. Cl. G01N 23/04; G06T 11/00

(52) U.S. Cl. CPC G01N 23/046; G06T 11/006; G06T 11/005

(57) ABSTRACT

The invention provides a reconstruction algorithm based on a theoretically exact analytic inversion formula that can be applied for cone beam data collected from the object that have been scanned by a moving source of radiation with two-dimensional array of detectors.

The said algorithm is applicable for arbitrary source trajectory that satisfies the completeness condition. The algorithm does not depend on the trajectory except for a precomputed weight function.

The algorithm does not contain the derivative of the cone beam data with respect to the position of the source. This guarantees its stability to noise and to numerical errors.

The number of elementary operations is optimally bounded with respect to the number of voxels in the object.

The said algorithm admits a high instruction level of parallelism for reducing the computing time.

### CROSS-REFERENCE TO RELATED APPLICATIONS

Not Applied

Related US Patent Documents

| | | |
|---|---|---|
| 5,881,123 | March 1999 | Tam |
| 6,097,784 | August 2000 | Tuy |
| 6,104,775 | August 2000 | Tuy |
| 6,574,299 | June 2003 | Katsevich |
| 6,771,733 | August 2004 | Katsevich |
| 6,804,321 | October 2004 | Katsevich |
| 6,898,264 | May 2005 | Katsevich |
| 6,907,100 | June 2005 | Taguchi |
| 7,010,079 | March 2006 | Katsevich |
| 7,280,632 | October 2007 | Katsevich |
| 7,305,061 | December 2007 | Katsevich |
| 7,403,587 | July 2008 | Bontus et al. |
| 7,548,603 | June 2009 | Bontus et al. |
| 7,778,387 | August 2010 | Koehler, et al. |
| 7,848,479 | December 2010 | Katsevich |
| 8,619,944 | December 2013 | Dennerlein |
| 8,805,037 | August 2014 | Pack |

### OTHER RELATED REFERENCES

Thy H. K.: An inversion formula for cone-beam reconstruction, SIAM J. Appl. Math., 43 (1983) N3, 546-552
Grangeat, P.: Mathematical framework of cone beam 3D reconstruction via the first derivative of the Radon transform, Mathematical Methods in Tomography (Lecture Notes in Mathematics 1497) (1991) pp. 66-97
Tam, K. C., Samarasekera, S. and Sauer F.: Exact come beam CT with a spiral, Phys. Med. Bio. 43 (1998), 1015-1024.
F. Noo, F., Defrise, M. and Clack, R.: Direct reconstruction of cone-beam data acquired with a vertex path containing a circle, IEEE Trans. Medical Imaging, vol. 7, (1998) N6, 854-867
Katsevich, A.: A general scheme for constructing inversion algorithms for cone beam CT, Preprint, 2002, Dept. of Math. University of Central Florida, Orlando. (Int. J. Math. Math. Sci. 2003, 21, 1305-1321)
Katsevich, A.: Image reconstruction for the circle and line trajectory, Phys. Med. Biol. 49 (2004), 5059-5072
Katsevich, A.: An improved exact filtered backprojection algorithm for spiral computed tomography, Adv. in Appl. Math. 32 N4 (2004) 681-697
Pack, J. D., Noo, F. R. and Clackdoyle, R.: Cone-beam reconstruction using the backprojection of locally filtered projections, IEEE Trans. Medical Imaging. 24 (2005), 70-85
Pack, J. D. and Noo, F. R.: Cone-beam reconstruction using 1D filtering along the projection of M-lines, Inverse Problems 21 (2005) 1105-1120
Ye, Y., Zhao, S., Yu, H. and Wang, G.: A general exact reconstruction for cone-beam CT via backprojection-filtration, IEEE Trans. Medical Imaging 24 (2005) N9, 1190-1198
Zou, Y., Pan, X., Xia, D. and Wang, G.: PI-line-based image reconstruction in helical cone-beam computed tomography with a variable pitch, Medical Physics. 32 (2005), 2639-2648
Zhuang, T., Leng, S. Nett, B. E. and Chen, G.: Fan-beam and cone-beam image reconstruction via filtering the backprojection image of differentiated projection data, Phys. Med. Biol. 51 (2006), 3189-3210
Katsevich, A.: 3PI algorithms for helical computer tomography, Adv. in Appl. Math. 36 (2006) N3, 213-250
Katsevich, A.: Zamyatin, A.: Analysis of a family of exact inversion formulas for cone beam computer tomography, Integral geometry and tomography. 59-73, Contemp. Math., 405, Amer. Math. Soc., Providence, R.I. (2006)
Chen, G. H., Zhuang, T. L., Leng, S. and Nett, B. E.: Shift-invariant and mathematically exact cone-beam FBP reconstruction using a factorized weighting function, IEEE Trans. Medical Imaging 51 (2006), 3189-3210
Zhuang, T. and Chen, G. H.: New families of exact fan-beam and cone-beam image reconstruction formulae via filtering the back projection image of differentiated projection data along singly measured lines, Inverse Problems. 22 (2006), 991-1006
Bontus, C., Koken, P., Kohler, Th. and Proksa, R.: Circular CT in combination with a helical segment, Phys. Med. Biol., 51 (2007), 107-120
Kapralov, M.; Katsevich, A.: A study of 1PI algorithms for a general class of curves, SIAM J. Imaging Sci. 1 (2008) N4, 418-459
Palamodov, V.: An algorithm for full 3D reconstruction with an arbitrary trajectory, Proceedings of the conference “Fully 3D Image Reconstruction in Radiology and Nuclear Medicine” (2013) Lake Tahoe, Calif.

### STATEMENT REGARDING FEDERALLY SPONSORED RESEARCH OR DEVEL-OPMENT

Not Applicable

### THE NAMES OF THE PARTIES TO A JOINT RESEARCH AGREEMENT

Not Applicable

### REFERENCE TO A SEQUENCE LISTING, A TABLE, OR A COMPUTERPROGRAM, LISTING COMPACT DISC APPENDIX

Not Applicable

### BACKGROUND AND PRIOR ART

Field of the invention. This invention relates to computer tomography, and in particular, to methods and systems for reconstructing three-dimensional images from the cone beam data obtained by a source of radiation moving along a piecewise smooth trajectory of arbitrary form.

Here and further the data provided by the two-dimensional detectors will be re-ferred to as cone-beam (CB) data. Mathematically, the problem of image reconstruction in computer tomography (CT) consists of finding an unknown function from its integrals along rays with sources on a curve. The curve is called the source trajectory, and the collection of line integrals is called the cone beam data.

A typical CT scanner consists of two major parts: a gantry and patient table. The gantry is a C-arm shaped device, where an x-ray source and x-ray detector are located opposite each other. The patient lies on the table, which is then inserted into the rotating gantry. By varying the motion of the table through the gantry one obtains different source trajectories. A saddle trajectory can be obtained by means of two rotating gantries.

The simple circular trajectory is incomplete. For this reason a pure circular scan is complemented by an additional trajectory, such as a line, arc, helical segment, etc., which makes it complete. So the problem of developing a reconstruction algorithm for more general trajectories is of significant practical interest. Theoretically exact and efficient filtered back projection (FBP) algorithms have been developed for spiral trajectories, for a number of specific circle-plus trajectories.

An exact algorithm is an algorithm based on an exact analytic formula. Under ideal circumstances, an exact algorithm provides a replication of an exact image. In real circumstances it produces images of good quality that depends on technical level of the equipment used and of density of the cone beam data. However, such algorithms are known to take many hours to provide an image reconstruction, and can take up great amounts of computer power. These algorithms can require keeping considerable amounts of cone beam projections in memory.

The most of reconstruction algorithms can be divided in several groups:

(I) The Feldkamp algorithm.

(II) Slice-by-slice application of the inverse two-dimensional Radon transform.

(III) Computing of the first derivative of the Radon transform by the method of Grangeat followed by inversion by means of Lorentz's formula.

(IV) Grangeat's method followed by the Fourier transform.

(V) FBP algorithms for reconstruction by means by Hilbert filtration on specially chosen planes of the derivative of the CB data along the trajectory.

(VI) BFP algorithms for reconstruction along R-lines.

We compare these methods in view of the following desirable properties:

(1) It is exact.

(2) It is applicable for arbitrary trajectory Y that satisfies Tuy's completeness condition. Tuy's condition is theoretically necessary: if it is violated a stable reconstruction of the volume of interest (VOI) is impossible.

(3) It does not use the derivative of the ray data with respect to the position of the source in Y. Comparing with other algorithms, this property makes the reconstruction more stable with respect to deviation of the source position and to any other noise.

(4) The number of elementary operations equals O(N⁴) (which is the minimal order of the number of operations) where N3 is the number of voxels in VOI.

(5) It admits a high instruction level of parallelism.

None of the above methods possesses all the properties 1-5. Method (I) is not exact, method (II) lacks property (2) and slow, since the trajectory is of length O(N). Method (III) does not fulfil (4) and (5). Implementation of (IV) includes an interpolation from spherical grid to the Cartesian one in the frequency space. This makes an obstruction to (5). Katsevich's algorithm works effective for spiral curves and was adapted for some non spiral curves. Property (5) does not hold for these methods. Algorithms (VI) can be applied only to points in VOI that belong to a R-line that is to a chord of the trajectory Y. They do not fulfil (2) and (5).

### BRIEF SUMMARY OF THE INVENTION

The objective of the invention is to provide a scheme for creating a numerical algorithm for reconstruction of an attenuation function in a volume of interest that have been scanned with two-dimensional array of detectors and a source trajectory Y. The said algorithm is theoretically exact, it can be adapted to an arbitrary source trajectory Y that fulfils Tuy's condition. The algorithm does not assume computation of derivative along the source trajectory. The reconstruction is more stable with respect to variations of the position of the radiation source, of impulse energy and to any other noise comparing with methods that depends on the trajectory derivative. The algorithm is numerically stable since no other derivative is to be computed pointwise.

The proposed algorithm has a simple structure, the form of the trajectory is encoded in the weight function that must be precomputed only once. The said algorithm can be easily reformatted for another trajectory simply by replacing the weight function. Since there is no trajectory derivative in the algorithm, the computer memory keeps just one CB projection at a time. The algorithm contains only O(N⁴) elementary operations where N³ is the number of voxels. The computing time for elementary operations in the algorithm can be essentially reduced by means of instruction level parallelism in multicore processors.

### BRIEF DESCRIPTION OF THE DRAWINGS

FIG. 1 depicts a possible embodiment. The source of penetrating radiation emits a cone-shaped beam of radiation that passes through the examination region as the rotating gantry rotates. A subject support holds a subject being examined within the examination volume while two rotating gantries are rotated. In this manner, the source of penetrating radiation follows a chosen trajectory relative to the subject. A two-dimensional array of radiation detectors is arranged to receive the radiation emitted from the source after it has traversed the examination volume.

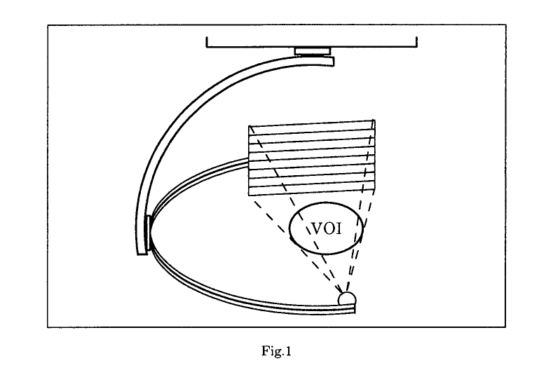

The invention can be used for any other C-arm assembly. The standard construction with one rotating gantry and a moving bed is also a possible embodiment.

FIG. 2 shows a possible embodiment with the trajectory consisting of two circles in non-parallel planes and illustrates determining the weight function for this trajectory.

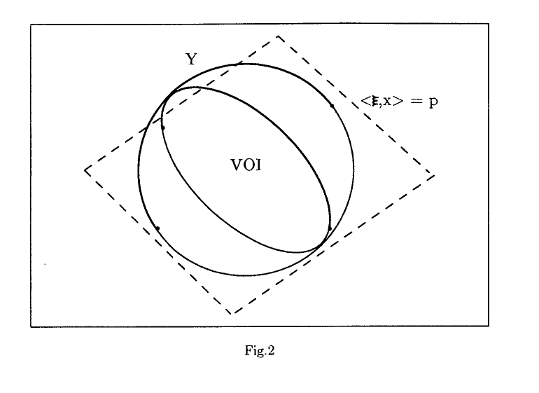

FIG. 3 shows a possible embodiment with a trajectory Y made of two circles in parallel planes and a connecting segment.

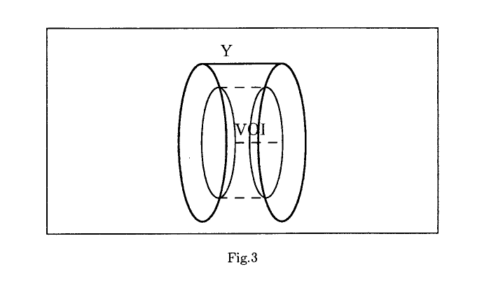

FIG. 4 depicts the icosahedron that is used for construction of the mesh in the sphere.

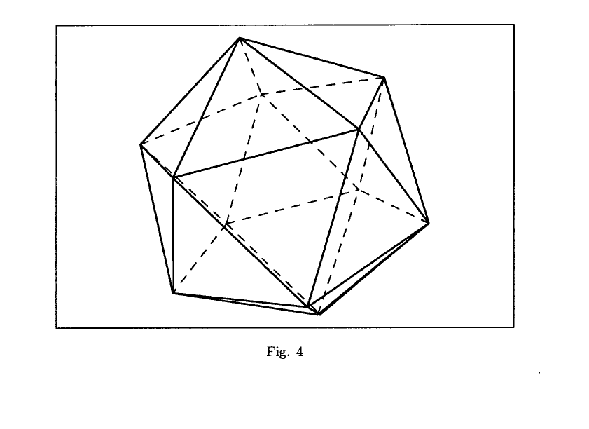

FIG. 5 depicts a fragment of the icosahedron mesh.

FIG. 6 illustrates integration in Step 11 of the algorithm.

FIG. 7 illustrates integration in Steps 12 and 13 of the algorithm.

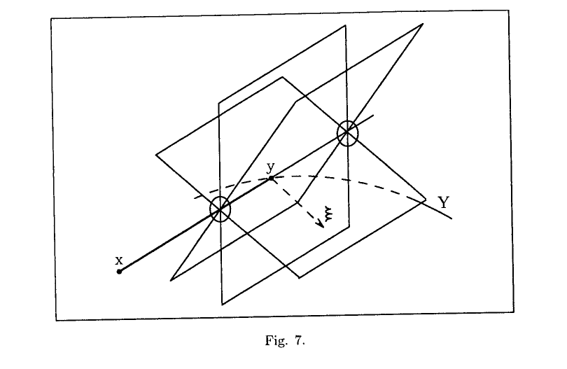

FIG. 8 illustrates construction of the weight function for an arbitrary closed trajectory.

### DETAILED DESCRIPTION OF THE INVENTION

This is a flexible new algorithm for accurate cone beam reconstruction with source positions on a curve (or set of curves). The algorithm disclosed herein is based on exact analytical reconstruction formulas. The only condition is that each plane which touches the volume of interest meets the trajectory Y at a point with a non zero angle.
Step 1 Let S² be the sphere of radius 1, in R³ and N be a natural number. Choose an icosahedral mesh S_{N} of cells σ(k)⊂S², k=1, . . . , 20N².

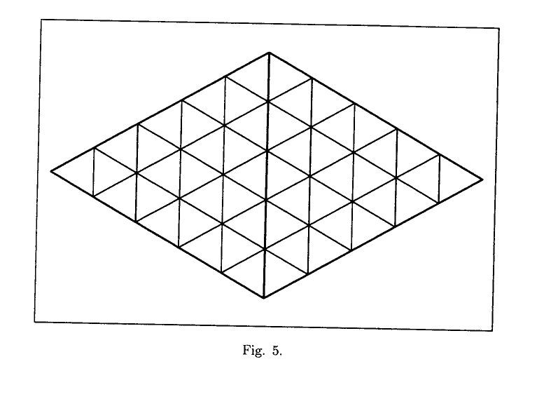

Details: The icosahedral mesh S_{N} in the unit sphere S² is the image of a triangular mesh I_{N} on the icosahedron I inscribed in S². The edges of I are equal to α=1.0515. The icosahedron has 12 vertices, 30 edges and 20 faces which are regular triangles. Each face is divided in N² cells that are regular triangles with the edge α/N see FIG. 5. The total of cells is 20N². Typically N≧10⁻³.

[symbol] [0058] Step 2 Choose coefficients cₖ (z) for interpolation of an arbitrary function h defined on the mesh S_{N} to a point zεS².

Details: A simple option is to interpolate by h(z)=1/3Σh(ξ(k)) where the sum is taken over all vertices of a cell σ that contains z.

[symbol] [0061] Step 3 Let X be a domain of interest (VOI) in R³ of volume V.
   Let X_{N} be the cubic mesh in X with edges equal V/N³ and the nodes x(i)εX, i=1, . . . , N³.

[symbol] [0064] Step 4 Choose an analytic parametrization y=y(s)=(y₁(s), y₂(s), y₃(s)), 0≦s≦1 of Y such that yᵢ(s), i=1, 2, 3 has bounded first derivatives.

[symbol] [0066] Step 5 Let y(j)εY, j=1, . . . , N_{Y} be positions of the X-ray source for acquisition of CB data such that |y(j+1)−y(j)|≦1/2N for all required j.
   Compute y′(j)=∂y/∂s|_{y=y(j)} for all required j.

[symbol] [0069] Step 6 Compute z(i,j)=|x(i)−y(j)|⁻¹(x(i)−y(j)) and determine the cell σ(i,j)εS_{N} such that z(i,j)εσ(i,j).

[symbol] [0071] Step 7 Compute a differntiable function w(y,ξ) defined for yεY,ξεS² (weight function) that satisfies Σⱼw(y(j),ξ(k))=1,
   where the sum is taken for all j such that l/N≦<(y(j),ξ(k)>≦(l+1)/N for all l=1, . . . , N_{Y}−1 and all required k.

Details: For a vector ξ=(ξ₁,ξ₂,ξ₃), we write <y,ξ>=y₁ξ₁+y₂ξ₂+y₃ξ₃. A weight function w must fulfil the equation

$${\sum }_{y ∈ Y , 〈 y , ξ 〉 = p}^{ } w ( y , ξ ) = 1$$

for any ξεS² and pεR such that there is at least one point yεY such that <y,ξ>=p. We assume that the number of such points is finite.

Moreover, w has to satisfy the condition w(y,ξ)=0 if <y′,ξ>=0, where y′₁,y′₂,y′₃) and there are at least two such points y.

The function

$$w ( y , ξ ) = \frac{\vert 〈 {y}^{′} , ξ 〉 \vert}{E ( 〈 y , ξ 〉 , ξ )} , where E ( p , ξ ) = {\sum }_{y ∈ Γ , 〈 y , ξ 〉 = p} \vert 〈 {y}^{′} , ξ 〉 \vert$$

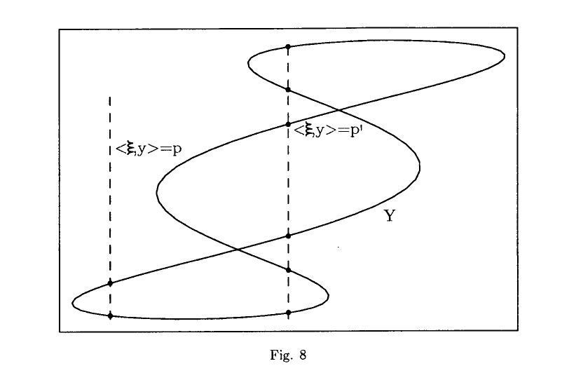

is continuous and fulfils these conditions. FIG. 8 illustrates this formula.

[symbol] [0077] Step 8 Compute ∂w(y,ξ(k))/∂s|_{y=y(j)} and ∇_{ξ}w(y(j),ξ)|_{ξ=ξ(k)} for all j and k, where ∇_{ξ}=(∂/∂ξ₁,∂/∂ξ₂,∂/∂ξ₃).

[symbol] [0079] Step 9 Compute Ω(y(j),ξ(m),ξ(k))=sgn [symbol] y′(j),ξ(k) [symbol] (∂w(y(j),ξ(k))/∂s− [symbol] y′(j),ξ(k)) [symbol] [symbol] ξ(m),∇_{ξ} [symbol] w(y(j),ξ(k))) for all j, k and m such that [symbol] ξ(m),ξ(k) [symbol] ≦λ/N.

Details: The number of elementary operations is O(N⁴).

[symbol] [0082] Step 10 Load in the computer the CB data g={g(y(j),v_{j,q})} obtained for an attenuation function ƒ at the position y(j) of the source and the positions d_{j,q}, q=1, . . . , Q of detectors in the coordinate system of the object.
   Set v_{j,q}=|d_{j,q}−y(j)|⁻¹(d_{j,q}−y(j)).

Details: CB data g(y(j),v_{j,q}) can be used immediately for Step 11 and deleted before the next scan with the source at yⱼ₊₁ is implemented. Also computations at Steps 12 and 13 depend only on this beam data.

[symbol]

$$Step 11$$

$$Let λ > 0 be a parameter λ {⋓}_{⋒} 1 \text{/} N . \\ For any point y ( i ) ∈ Y and any ξ ( k ) ∈ {S}_{N} , \\ denote Λ ( k ) = \{ {v}_{j , q} ; \vert 〈 ξ ( k ) , {v}_{j , q} 〉 \vert \leq λ \} and compute$$

$$G ( y ( j ) , ξ ( k ) ) = {λ}^{- 2} {\sum }_{σ} {\sum }_{{v}_{j , q} ∈ σ ⋂ Λ ( k )} \\ sgn 〈 ξ ( k ) , {v}_{j , q} 〉 g ( y ( j ) , {v}_{j , q} ) \frac{\vert σ \vert}{n ( σ )} , \\ where \vert σ \vert is the spherical area of the cell σ ∈ {S}_{N}$$

$$and n ( σ ) is the number of vectors {v}_{j , q} ∈ σ ⋂ Λ ( k ) .$$

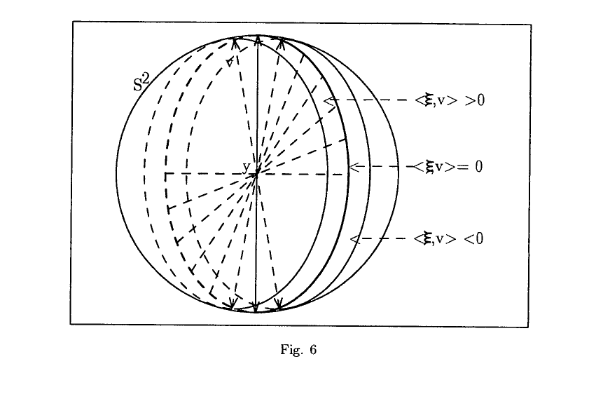

Details: This computation combines numerical differentiation <(k),∇ᵥ>g(y(j),v) together with the integration of the result along the circle {v;<ξ(k),v>=0}. This numerical method is more stable than the pointwise differentiation which is ill-conditioned. The para-meter λ which regulates the with of the strip in the sphere S² the must be optimally chosen. FIG. 6 illustrates this operation.

Number of elementary operations at this step is O(N⁴).

[symbol]

$$Step 12$$

$$Compute the sum U ( y ( j ) , ξ ( m ) ) = {\sum }_{σ} {\sum }_{k , ξ ( k ) ∈ σ , \vert 〈 ξ ( m ) , ξ ( k ) 〉 \vert \leq λ} Ω ( y ( j ) , ξ ( m ) , ξ ( k ) ) G ( y ( j ) , ξ ( k ) ) \frac{\vert σ \vert}{( m , σ )}$$

$$for all required j , m , where p ( m , σ ) is the number of points$$

$$ξ ( k ) ∈ σ such that \vert 〈 ξ ( m ) , ξ ( k ) 〉 \vert \leq λ .$$

Details: Number of elementary operations is O(N⁴).

[symbol]

$$Step 13$$

$$Compute sum V ( y ( j ) , ξ ( m ) ) = {\sum }_{σ} {\sum }_{k , ξ ( k ) ∈ σ , \vert 〈 ξ ( m ) , ξ ( k ) 〉 \vert \leq λ} \\ \vert 〈 {y}^{′} ( j ) , ξ ( k ) 〉 \vert 〈 ξ ( m ) , {∇}_{ξ} 〉 w ( y ( j ) , ξ ( k ) ) G ( y ( j ) , ξ ( k ) ) \frac{\vert σ \vert}{( m , σ )}$$

$$for all required j , m .$$

Details: Number of elementary operations is O(N⁴).

[symbol] [0093] Step 14 Compute L(x(i),y(j))=1/3 Σₘ [|x(i)−y(j)|⁻¹U(y(j),ξ(m))−|x(i)−y(j)|⁻²V(y(j), ξ(m))], where the sum is taken over vertices ξ(m)εσ(i,j), for all required i,j.

Details: Number of operations is again O(N⁴).

[symbol] [0096] Step 15 If the curve Y is closed curve, that is y(s=1)=y(s=0), compute F(x(i))=(8π²)⁻¹Σⱼ(y(j)−y(j−1))L(x(i),y(j)) for i=1, . . . , N³.
   The function F is the reconstruction of ƒ.

Details: If a simple curve Y is not closed one more term should be added to the quantity obtained in the next step.

[symbol] [0100] Step 16 If the trajectory Y is not closed, compute number (8π²)⁻¹[K(x(i),y(1))−K(x(i),y(N))] where K(x(i),y(j))=1/3|x(i)−y(j)|⁻¹Σₘsgn [symbol] (y′(j),ξ(m) [symbol] w(y,ξ(m))G(y(j),ξ(m)) and the sum is taken over all m such that ξ(m)εσ(i,j), for all required i and j=1, N.

The algorithm works also for an arbitrary curve Y that is union of finite number of simple curves Y₁, . . . , Yₘ. The sum of results of Steps 15 and 16 for all the pieces.

The sum G computed at Step 11 is an approximation for the integral

[symbol]

ξ,∇ᵥ [symbol] ∫_{<ξ,v>=0}g(y,v)dφ

taken along the circle {v; [symbol] ξ,v [symbol] =0}.

The sum U obtained in Step 12 is an approximation for the integral

$${\int }_{〈 y - z , ξ 〉 = 0} sgn 〈 {y}^{′} , ξ 〉 ( \frac{\partial }{\partial s} w ( y , ξ ) - 〈 {y}^{′} , z 〉 w ( y , ξ ) ) ( 〈 ξ , {∇}_{v} 〉 {\int }_{〈 ξ , v 〉 = 0} g ( y , v ) d θ ) d ϕ$$

$$where z = {\vert y - x \vert}^{- 1} ( y - x ) .$$

The sum V calculated at Step 13 is a approximation for the integral

∫_{<y-x,ξ>=0}| [symbol] y′,ξ [symbol] | [symbol] z,∇_{ξ} [symbol] w(y,ξ)( [symbol] ξ,∇ᵥ [symbol] ∫_{<ξ,v>=0}g(y,v)dθ)dφ.

The function L found at Step 14 is an approximation for the integral

$${\int }_{〈 y - z , ξ 〉 = 0} sgn 〈 {y}^{′} , ξ 〉 ρ ( \frac{w ( y , ξ )}{\vert y - x \vert} ) 〈 ξ , {∇}_{v} 〉 {\int }_{〈 ξ , v 〉 = 0} g ( y , v ) d θ d ϕ , \\ ρ ≃ \frac{\partial }{\partial s} - \frac{〈 {y}^{′} , ξ 〉}{\vert y - x \vert} 〈 z , {∇}_{ξ} 〉$$

Finally, the function F at Step 15 approximates the integral

$${( 8 {π}^{2} )}^{- 1} {\int }_{0}^{1} d s {\int }_{〈 y - z , ξ 〉 = 0} sgn 〈 {y}^{′} , ξ 〉 ρ ( \frac{w ( y , ξ )}{\vert y - x \vert} ) 〈 ξ , {∇}_{v} 〉 {\int }_{〈 ξ , v 〉 = 0} g ( y , v ) d θ d ϕ ,$$

which provides an exact reconstruction.

Properties of the algorithm:

Steps 1-3 do not depend on the source trajectory Y.

Steps 1-9 do not depend on the cone beam data g.

Steps 8-14 are to be done for each position y(j), j=1, . . . , N_{Y} independently.

Steps 9 and 10 can be implemented in parallel for all j, and l in a multicore processor.

Step 11 can be implemented in parallel for all j and l.

Step 12 can be implemented in parallel for all j and m.

Step 13 can be implemented in parallel for all j and m.

Step 14 can be implemented in parallel for all j and i.

The algorithm does not contain derivative of cone beam data along Y. Moreover, no derivative is computed pointwise at all. The only the numerical integral of the normal ξderivative over the circle [symbol] ξ,v [symbol] =0 is computed at Step 11.

The total number of elementary operation is O(N⁴).

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

### SEQUENCE LISTING

Not Applicable

I claim:

1. A method for determining the exact attenuation coefficient function of an object using a movable x-ray source and an array of detectors, which are provided for recording projections specifying a trajectory path Y comprising the following steps:
(a) choosing a mesh in the sphere of directions and computing a special weight function depending on volume of interest X and on the trajectory Y,
(b) scanning the object using an x-ray source moving along Y and the array of detectors collecting cone beam data of the object,
(c) for each position of the source y in Y, computing the normal derivative of the integral of the said cone beam data along a variable big circle in the sphere of directions and storing the results in the memory,
(d) computing integral means of the said integrals with the said weight function along the set of all normals orthogonal to the vector z from a point yεY to a reconstruction point x in X and storing the results in the memory,
(e) computing backprojection of the said integrals along the trajectory Y for all required points x.

2. A formula for determining the said weight function as it is described in [0042].
